(19) United States
(12) Patent Application Publication
(10) Pub. No.: US 2026/0360034 A1
(43) Pub. Date: Nov. 12, 2026

(54) SYSTEMS AND METHOD FOR GENERATING AUGMENTED IMAGES

(71) Applicant: Walmart Apollo, LLC, Bentonville, AR (US)

(72) Inventors: Ishan Vasishta Bhatt, Fremont, CA (US); Yi-Sheng Yang, San Jose, CA (US); Quoc Tan Tran, Los Gatos, CA (US)

(21) Appl. No.: 19/200,340

(22) Filed: May 6, 2025

(51) Int. Cl. G06T 11/60; G06T 7/00

(52) U.S. Cl. CPC G06T 11/60; G06T 7/0002; G06T 2207/30168

(57) ABSTRACT

An example method includes receiving a request to generate an augmented image for an item set and retrieving, from a communicatively coupled database, image data based request. The method includes generating, using an image processor, preprocessed image data including a selected portion of an item of the item set. The image processor generates the preprocessed image data at predetermined rate satisfying a computational resources requirement. The method includes generating, using a plurality of image augmentors, candidate augmented images that have estimated scores satisfying a quality threshold. The method further includes determining, based on an image scorer, a respective score for each candidate augmented image of the candidate augmented images, selecting the augmented image for the item set from the candidate augmented images based on the respective score for each candidate augmented image, and providing the augmented image for the item set to a communicatively coupled device.

### TECHNICAL FIELD

This disclosure relates generally to the generation of augmented images, and more particularly, to systems and methods for processing images to generate augmented images that satisfy different platform needs.

### BACKGROUND

Platforms use user interfaces to present images. Each of the images may need to satisfy platform requirements. Generating images that satisfy platform requirements can be a time-consuming task and/or utilize several computational resources. For example, in some instances, images need to be manually created to satisfy platform requirements. In other cases, images are automatically generated using one or more algorithms or models (e.g., deep learning models and optimizers); however images generated using the one or more algorithms are not always presentable and can take a considerable amount of time to generate.

### BRIEF DESCRIPTION OF THE DRAWINGS

Various examples will be described below with reference to the following figures.

FIG. 1 depicts an example system 100 that generates augmented images, in accordance with some embodiments.

FIG. 2 depicts an overview of an example system for generating augmented images, in accordance with some embodiments.

FIG. 3 depicts an example process for preprocessing an image, in accordance with some embodiments.

FIG. 4 depicts an example process for removing banners from an image, in accordance with some embodiments.

FIG. 5 depicts example generated crates for augmented images, in accordance with some embodiments.

FIG. 6 depicts first example augmented images, in accordance with some embodiments.

FIG. 7 depicts second example augmented images, in accordance with some embodiments.

FIG. 8 depicts third example augmented images, in accordance with some embodiments.

FIG. 9 depicts a flow diagram of an example method for generating an augmented image, in accordance with some embodiments.

FIG. 10 depicts an example method for generating an augmented image, in accordance with some embodiments.

FIG. 11 depicts an example method expanding on the method for generating an augmented image, in accordance with some embodiments.

FIG. 12 depicts an example system with a machine readable medium that includes instructions to generate an augmented image, in accordance with some embodiments.

FIG. 13 illustrates a block diagram of an example computing device 1200, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In accordance with some embodiments, a system for generating augmented images is disclosed. The system includes a processor and a non-transitory memory storing instructions. The instructions, when executed by the processor, cause the processor to receive a request to generate an augmented image for an item set, and retrieve, from a communicatively coupled database, image data based on the request. The instructions, when executed by the processor, further cause the processor to generate, using an image processor, preprocessed image data including a selected portion of an item of the item set. The image processor generates the preprocessed image data at predetermined rate satisfying a computational resources requirement. The instructions, when executed by the processor, also cause the processor to generate, using a plurality of image augmentors, a plurality of candidate augmented images, and determine, based on an image scorer, a respective score for each candidate augmented image of the plurality of candidate augmented images. The instructions, when executed by the processor, further cause the processor to select the augmented image for the item set from the plurality of candidate augmented images based on the respective score for each candidate augmented image, and provide the augmented image for the item set to a communicatively coupled device.

In accordance with some embodiments, a computer-implemented method for generating augmented images is disclosed. The method includes receiving a request to generate an augmented image for an item set, and retrieving, from a communicatively coupled database, image data based on the request. The method also includes generating, using an image processor, preprocessed image data including a selected portion of an item of the item set. The image processor generates the preprocessed image data at predetermined rate satisfying a computational resources requirement. The method further includes generating, using a plurality of image augmentors, a plurality of candidate augmented images, and determining, based on an image scorer, a respective score for each candidate augmented image of the plurality of candidate augmented images. The method also includes selecting the augmented image for the item set from the plurality of candidate augmented images based on the respective score for each candidate augmented image, and providing the augmented image for the item set to a communicatively coupled device.

In accordance with some embodiments, a non-transitory computer readable medium including instructions for causing at least one device to generate augmented images is disclosed. The non-transitory computer readable medium has instructions stored thereon. The instructions, when executed by at least one processor, cause at least one device to perform receiving a request to generate an augmented image for an item set, and retrieving, from a communicatively coupled database, image data based on the request. The instructions, when executed by at least one processor, cause at least one device to perform generating, using an image processor, preprocessed image data including a selected portion of an item of the item set. The image processor generates the preprocessed image data at predetermined rate satisfying a computational resources requirement. The instructions, when executed by at least one processor, cause at least one device to perform generating, using a plurality of image augmentors, a plurality of candidate augmented images, and determining, based on an image scorer, a respective score for each candidate augmented image of the plurality of candidate augmented images. The instructions, when executed by at least one processor, cause at least one device to perform selecting the augmented image for the item set from the plurality of candidate augmented images based on the respective score for each candidate augmented image, and providing the augmented image for the item set to a communicatively coupled device.

Furthermore, in the following, various embodiments are described with respect to methods and systems for generating augmented images. In various embodiments, the systems and methods disclosed herein generate augmented images that satisfy platform requirements efficiently without utilizing a substantial amount of computational resources. An augmented image, as described herein, in some embodiments, is an image including image data corresponding to one or more items—for example, images corresponding to item bundles, item stacks, item crates, and/or other image combinations. The augmented images are used to clearly and uniformly communicate information to users regarding one or more included items. The systems and methods disclosed herein generate high-quality and uniform augmented image quickly, cost-effectively, efficiently, and reliably. Because the systems and methods disclosed herein quickly and efficiently generate augmented images, augmented images can be generated for experimentation, test, customization, etc., and the augmented image generation process can be canceled without losing a substantial amount of time. The systems and methods disclosed herein are scalable and allow for the generation of aesthetically appealing augmented images quickly and, in some embodiments, without user prompting.

The systems and methods disclosed herein are an improvement over existing solutions, such as a deep learning based image generation system and naïve optimizers. Compared to the systems and methods disclosed herein, deep learning based image generation systems are generally slow, expensive, and require prompting and manual review without guaranteeing image quality. Naïve optimizers may not generate aesthetic images and may be unstable compared to the systems and methods disclosed herein.

The systems and methods disclosed herein may be useful for providing a quick, inexpensive, and reliable way to generate augmented images that are aesthetic and clearly and uniformly convey information to users. The systems and methods disclosed herein generate augmented images by solving one or more linear problems. The systems and methods disclosed herein are product type or item type agnostic (e.g., can be applied to any kind of product or item type); fast and inexpensive (e.g., without requiring heavy hardware and/or heavy software demands and dependencies); and reliable (e.g., by automatically publishing augmented images to a database). The systems and methods disclosed herein fail predictably such that the systems and methods can detect its own failures with post-generation quality-checks. Additionally, the systems and methods disclosed herein do not require prompts and/or do not need human review, monitoring, and/or feedback.

The systems and methods disclosed herein may generate aesthetically appealing images by optimizing linear equations. Using fast and computationally inexpensive image processing, the systems and methods disclosed herein include fast semantic segmentation optimized for extracting from an image items from a plain background; use fast and lightweight techniques to use color and geometric information to differentiate between banners and a product compared to deep learning techniques; include a unique component design to dynamically generate creates and/or banners to wrap around products and/or items of any size and/or shape using its components; and use a system of constrained linear models (and their solutions) to calculate how to scale and place items (and banners) in a canvas to generate aesthetically appealing bundle images. The systems and methods disclosed herein include fallback mechanisms to ensure that augmented images are always generated and perform quality checks to ensure that unaesthetically images are not generated and/or stored in a database.

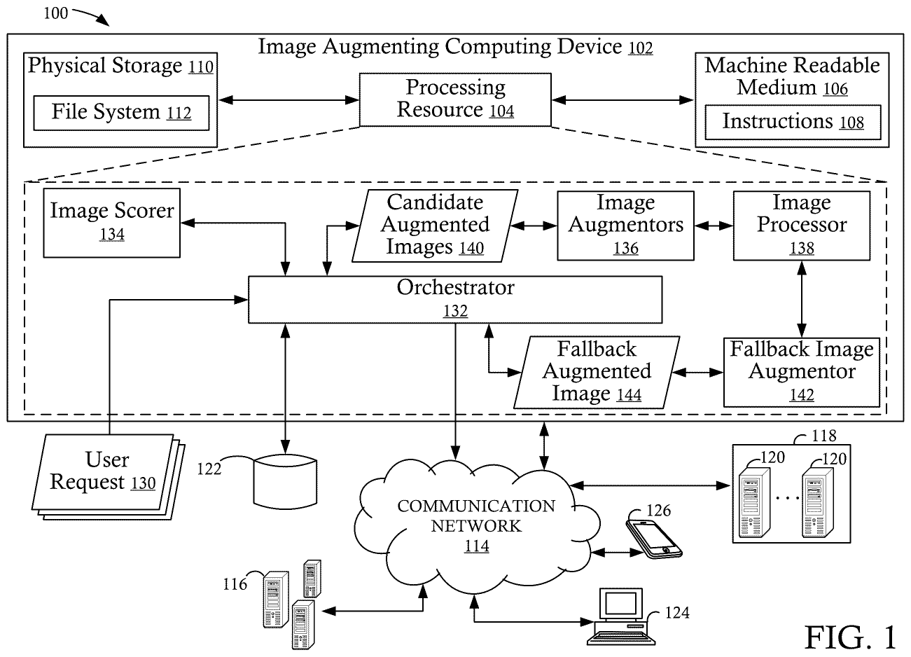

FIG. 1 depicts an example system 100 that generates augmented images, in accordance with some embodiments. The system 100 includes an image augmenting computing device 102 that generates one or more augmented images. The image augmenting computing device 102 includes a processor resource 104 that may include one or more microcontrollers, microprocessors, field-programmable gate arrays (FPGAs), application-specific integrated circuits (ASICs), state machines, digital circuitry, and/or any other suitable processing resource. The image augmenting computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processor resource 104 may execute instructions 108 (i.e., programming or software code) stored on machine readable medium 106 to perform functions of the image augmenting computing device 102, such as image scorers 134, image augmentors 136, image processors 138, fallback image augmentor 142, and an orchestrator 132. The instructions 108 may include instructions for implementing one or more models. In some embodiments, and as will be described further herein below, the image augmenting computing device 102 may execute one or more models, processes, or algorithms, such as a machine learning model, deep learning model, statistical model, etc., (e.g., as implemented as machine readable instructions) to generate augmented images.

The image augmenting computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the image augmenting computing device 102. In some implementations, physical storage 110 may be accessed as a block storage device.

In some cases, the image augmenting computing device 102 may also include a local file system 112 that may be implemented as a layer on top of the physical storage 110. For example, an operating system 112 may be executing on the image augmenting computing device 102 (by virtue of the processing resource 104 executing certain instructions 108 related to the operating system) and the operating system 112 may provide a file system 110 to store data on the physical storage 108.

The network 114 may include a plurality of devices or systems in communication with the image augmenting computing device 102 over one or more network channels, illustrated as a network cloud. For example, in various embodiments, the image augmenting computing device 102 may be in communication with a web server 116, a cloud-based engine 118 including one or more processing devices 120 that may be provisioned for use, a database 122, a workstation 124, and/or any other suitable system or device. The image augmenting computing device 102 may similarly be in communication, either directly or indirectly, with one or more user computing devices 126 operatively coupled over the network 114. The other computing systems may be similar to the image augmenting computing device 102, and may each include at least a processing resource and a machine readable medium.

The orchestrator 132 is configured to receive user requests 130, retrieve image data from the database 122, and/or distribute the user requests 130 and/or retrieved image data to generate augmented images. For example, the orchestrator 132 can receive the user requests 130 and retrieve image data based on the user request 130 and provide the user requests 130 and the image data to one or more image scorers 134, image augmentors 136, image processors 138, and/or fallback image augmentor 142. The orchestrator 132 distributes outputs from the one or more image scorers 134, image augmentors 136, image processors 138, and/or fallback image augmentor 142 between the components to determine the candidate augmented images 140 and the fallback augmented images 144. In some embodiments, the orchestrator 132 receives one or more scores from the image scorers 134 that are used to select an augmented image from the one or more of the candidate augmented images 140 and the fallback augmented images 144. Additionally, the orchestrator 132 provides an augmented image selected from one or more of the candidate augmented images 140 and the fallback augmented images 144 to a communicatively coupled device.

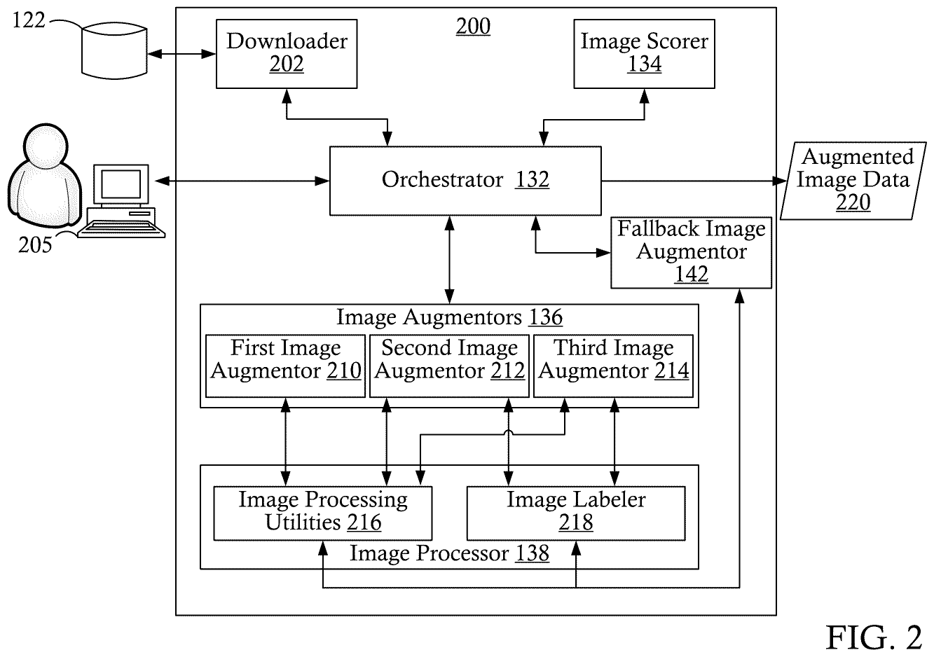

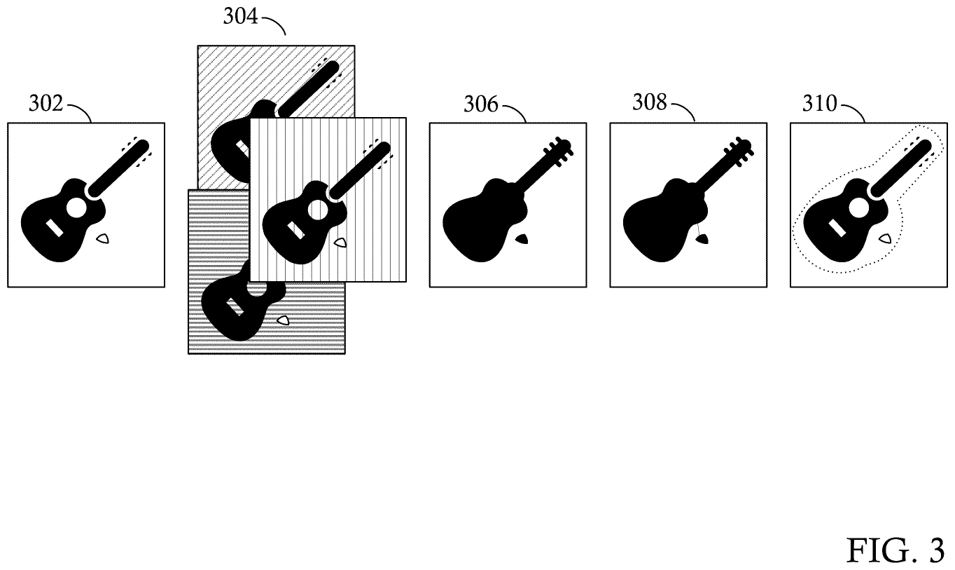

The image processors 138 receives image data corresponding to the user requests 130. The image processors 138 preprocesses the image data in preparation of generating the augmented image. The image processors 138 can include image processing utilities 216 and a cluster labeler 218 (FIG. 2). In some embodiments, the image processors 138 identifies items and/or products within the image data, identifies banners within the image data, removes background image data, and/or removes banners from the image data. Features of the image processors 138 are discussed below in reference to FIGS. 3-5.

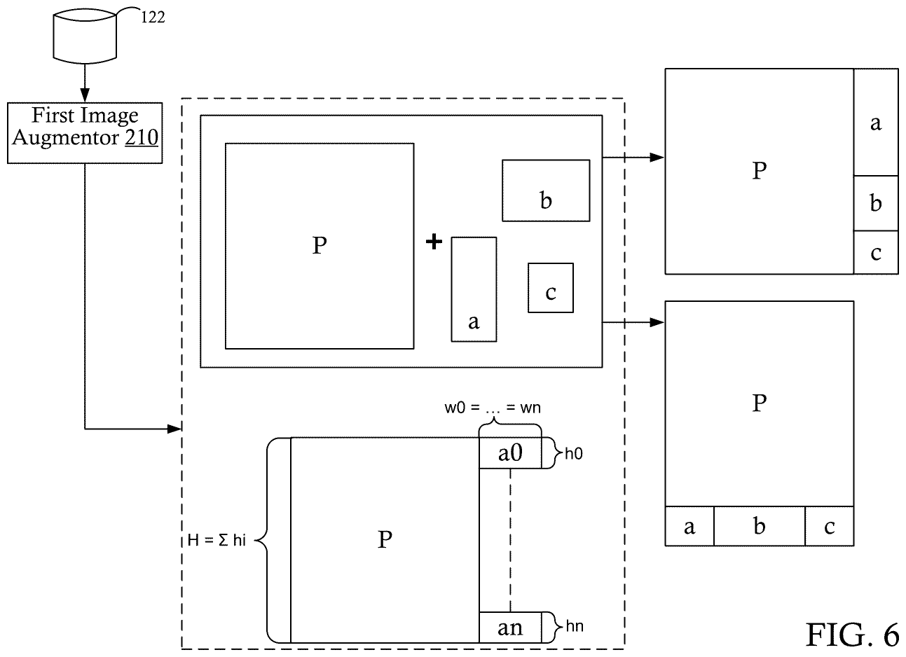

The image augmentors 136 receive preprocessed image data (from the image processor 138) and generate candidate augmented images 140. In some embodiments, a respective set of candidate augmented images is generated by each image augmentor of the image augmentors 136. In some embodiments, the image augmentors 136 include at least three image augmentors 136. In some embodiments, each image augmentor of the image augmentors 136 is operated in parallel and/or concurrently. The image augmentors 136 are described in detail below in reference to FIGS. 6-8.

The fallback image augmentor 142 generates the fallback augmented images 144. The fallback image augmentor 142 receives preprocessed image data (from the image processor 138) and applies one or more predetermined fallback policies to the preprocessed image data. The predetermined fallback policies are configured to generate fallback augmented images 144 that receive augmented image scores that satisfy augmented image score thresholds. The fallback augmented images 144 are used in accordance with a determination that the candidate augmented images 140 do not satisfy the augmented image score thresholds.

The image scorers 134 receives the candidate augmented images 140 and the fallback augmented images 144 and generates respective scores for each image of the candidate augmented images 140 and the fallback augmented images 144. In some embodiments, the image scorers 134 identifies images of the candidate augmented images 140 and the fallback augmented images 144 that have scores satisfying the augmented image score thresholds. Alternatively, or in addition, in some embodiments, the image scorers 134 provides the scores for the candidate augmented images 140 and the fallback augmented images 144 to the orchestrator 132.

In some embodiments, a user submits a query (e.g., user request 130) on a website hosted by the web server 116. The web server 116 may send a user request 130 to the image augmenting computing device 102. In response to receiving the user request 130, the image augmenting computing device 102 may execute one or more processes to generate augmented images and transmit the augmented images to the web server 116 to be displayed to the user.

FIG. 2 depicts an overview of a system for generating augmented images, in accordance with some embodiments. Aspects of system 200 for generating augmented images may be analogous to corresponding aspects of the image augmenting computing device 102. The system 200 includes a downloader 202, an image scorer 134, an orchestrator 132, a fallback image augmentor 142, one or more image augmentors 136, and an image processor 138. The system 200 can be accessed by a user 205 via one or more computing systems (e.g., a workstation 124). In some embodiments, the system 200 is accessible via an application.

In some embodiments, the system 200 can poll messages from a designated topic and/or store generated augmented images. In some embodiments, incoming messages (e.g., received via the workstation 124) can include one or more augmented image generation requests. The system 200, in response to the incoming messages (e.g., analogous to user request 130; FIG. 1), uses the orchestrator 132 to request or download image data associated with the incoming messages. For example, the orchestrator 132 can send instruction to the downloader 202 to retrieve image data from the database 122. In some embodiments, the system 200 first downloads or retrieves the image data associated with the incoming messages using the downloader 202. In some embodiments, the downloader 202 is a multi-threaded module. A multi-threaded module allows the system 200 to retrieve all associated image data from incoming messages including a plurality of requests for generating an augmented image. In some embodiments, the image data retrieval, using the downloader 202 (e.g., performing multi-threading), is done at the image data URL-level whereas other operations of the system 200 can be performed (e.g., multi-threaded) at a product-level or item-level. For example, after determining that an incoming message includes two requests for generating an augmented image (the two requests including 3 and 4 components, respectively), the system 200 retrieves, using the downloader 202, at least 7 images (e.g., for the 7 components) in parallel and, after downloading the 7 images, executes the two requests in parallel. By downloading the image data in parallel, the system 200 reduces waiting and processing times.

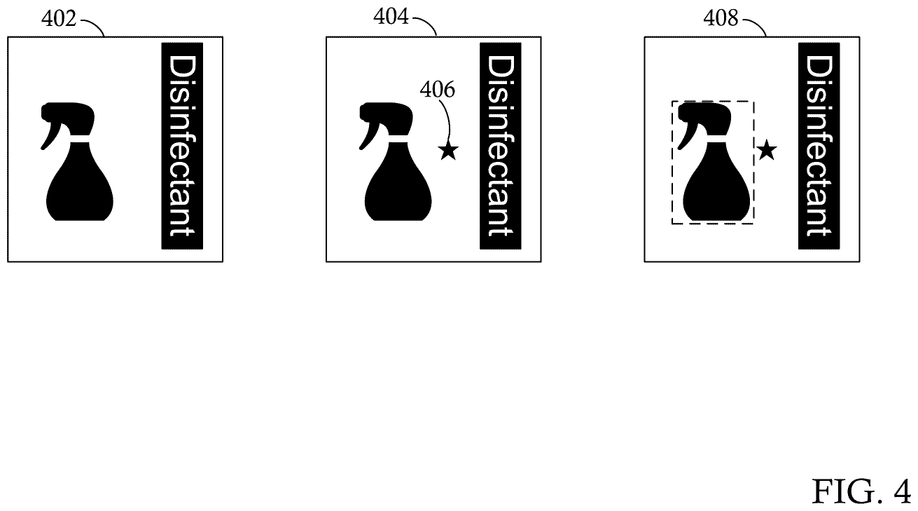

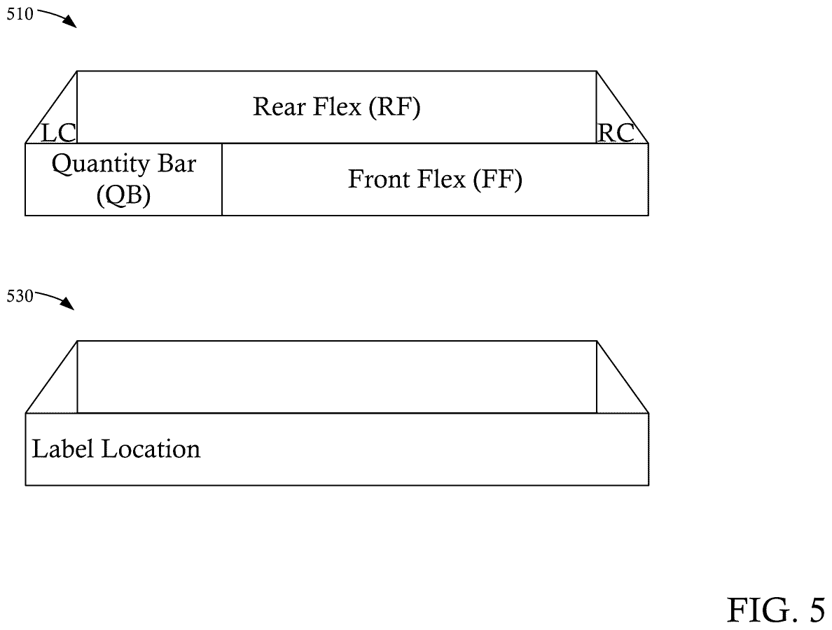

In some embodiments, the system 200 includes an image processor 138 that operates in parallel with one or more operations. In some embodiments, the image processor 138 includes image processing utilities 216 and a cluster labeler 218. The image processing utilities 216 are configured to identify items in the image data retrieved from the downloader 202 and removes background image data and/or banner data. The image processing utilities 216 are described below in reference to FIGS. 3-4. The cluster labeler 218 is configured to generate and/or scale crates and/or banners for placing items and/or products. The cluster labeler 218 is discussed below in reference to FIG. 5. In some embodiments, the image processing utilities 216 are used with each image augmentor of the image augmentors 136. In some embodiments, the cluster labeler 218 is used with a subset of the image augmentors 136 (e.g., a second image augmentor 212 and a third image augmentor 214).

In some embodiments, each request for generating an augmented image includes a request for one or more augmented image types. In some embodiments, a request for generating an augmented image includes a request for at least three augmented image types. A non-exhaustive list of augmented image types includes an image collage (or NonConfig type), an image stacking (or a VirtualPack), and an image grouping (or CasePack). In some embodiments, each augmented image type is generated by a respective image augmentor of the image augmentors 136. For example, image collage augmented image can be generated by a first image augmentor 210, an image stacking augmented image can be generated by a second image augmentor 212, and an image grouping augmented image can be generated by a third image augmentor 214. Each image augmentor can apply distinct rules and policies. In some embodiments, the rules and/or policies of the image augmentors 136 are systems of linear equations. The rules and/or policies of a respective image augmentor of the image augmentors 136 have access to the additional utilities that are used by the respective image augmentor. Each image augmentor can operate separately and/or in parallel.

Each image augmentor determines estimated quality scores for candidate augmented images that are about to be generated. In some embodiments, an image augmentor can cease generating a candidate augmented image (e.g., partially executing one or more rules and/or policies) and/or forgo generating the candidate augmented image in accordance with a determination that an estimated quality score for the (about to be generated) candidate augmented image would not satisfy augmented image quality thresholds. By determining estimated quality scores that satisfy augmented image quality thresholds, the system 200 can select the image augmentors 136 to use for generating the candidate augmented images. Because the image augmentors 136 can operate separately and/or in parallel and can cease operating when estimated quality scores for candidate augmented images do not satisfy augmented image quality thresholds, candidate augmented images can be generated faster and more efficiently.

In accordance with a determination that candidate augmented images generated by the image augmentors 136 do not satisfy augmented image score thresholds, the system 200 uses the fallback image augmentor 142 to generate fallback augmented images based on the requests for generating an augmented image. In some embodiments, the system 200 generates the fallback augmented images 144 in parallel with the candidate augmented images. The fallback image augmentor 142 applies rules and policies that are configured to generate augmented images that satisfy the augmented image score thresholds.

The orchestrator 132 receives the candidate augmented images and the fallback augmented images and provides the candidate augmented images and the fallback augmented images to the image scorer 134. The image scorer 134 determines augmented image scores for each of the candidate augmented images and the fallback augmented images. The system 200 can determine candidate augmented images and the fallback augmented images that satisfy the augmented image score thresholds. Candidate augmented images and the fallback augmented images that satisfy the augmented image score thresholds are stored (e.g., selected ads augmented image data 220).

FIG. 3 depicts an example process for preprocessing an image, in accordance with some embodiments. A preprocessing process 300 of the image processing utilities 216 (FIG. 2) is configured to remove background image data from retrieved image data. In some embodiments, the preprocessing process 300 is a fast semantic segmentation process. The preprocessing process 300 is optimized to extract items or products from a plain background at a fraction of the compute cost of other existing solutions (e.g., depending on the hardware and image resolution, existing solutions and techniques can require several seconds to several minutes per image). The preprocessing process 300 disclosed herein generate the preprocessed image data including a selected portion of an item or product at predetermined rate satisfying a computational resources requirement. For example, the preprocessing process 300 can generate the preprocessed image data at a (fast) predetermined rate (e.g., approximately 500 ms/image) while consuming negligible memory (when compared to existing solutions and techniques).

The preprocessing process 300 includes receiving image data 302 and dividing the image data 302 into a plurality of component parts 304. In some embodiments, the plurality of component parts 304 are distinct color components. For example, the image data 302 can be divided into red, green, and blue component parts (represented by gradient patterns). The preprocessing process 300 applies a filter to each component part of the plurality of component parts 304. The filter identifies deviation from pure white in the component part of the plurality of component parts 304. For each pixel of the component part of the plurality of component parts 304, the preprocessing process 300 identifies pixels that deviate from pure white as part of the item (or product) and/or the non-white background. After combining the pixels identified as part of the item (or product) and/or the non-white background, a combined mask 306 is generated.

The preprocessing process 300 further applies morphological closing followed by morphological opening to smoothen the edges and remove noise. The morphology and connections are shown in image 308. The number of connections is based on the number parts of an item in an image 308. More specifically, the number of connections can be represented by the following equation

$$number of connections = \frac{N * ( N - 1 )}{2} ,$$

where N is the number of parts of an item. For example, in image 308, there are two parts of an item (e.g., the guitar and the pick; N=2) and, as such, there is a single connection between the guitar and pick in image 308

$$( e . g . , \frac{2 * ( 2 - 1 )}{2} = 1 ) .$$

The preprocessing process 300 further connects all the valid portions of the image data by drawing a white line between each of their mid-points and returns the preprocessed image data 310.

FIG. 4 depicts an example process for removing banners from an image, in accordance with some embodiments. The banner removal process 400 provides a fast and lightweight technique to use color and geometric information to differentiate between banners and an item or a product compared to existing techniques (e.g., deep learning techniques). The banner removal process 400 can be part of the image processing utilities 216. Image data for items or products can include banners denoting the size, quantity, weight, branding, and/or other item or product information. In some embodiments, the image processing utilities 216 are applied to image data to detect and remove banners.

The banner removal process 400 uses one or more proxies to determine whether candidate object image data (e.g., a portion of image including a potential item or product) corresponds to an item or a product. Each of the proxies is assigned distinct weights that are used to determine if a portion of image data is an item (or product) or a banner. Example weights for the different proxies are provided below in Table 1. The banner removal process 400 classifies candidate object image data as an item (or product) if a sum of the proxies for the candidate object image data is above a proxy threshold (e.g., at least 2, at least 3, etc.). If image data includes at least two candidate objects, the banner removal process 400 determines proxy values and proxy sums for respective candidate object image data (e.g., first candidate object image data and second candidate object image data), determines proxy sums for the respective candidate object image data that are above the proxy threshold, and classifies the candidate object image data with the highest proxy sum as an item or product. Alternatively, the banner removal process 400 provides image data to the fallback image augmentor 142 when an item or product cannot be detected within the image data (e.g., respective proxy sums of all the candidate object image data are below the proxy threshold).

TABLE 1

| Proxy | Description | Weight | Winner |
|---|---|---|---|
| candidate object image data | Area of the candidate object image data | 1.0 | Max |
| distance(candidate object | Distance from the center of the image data to the | 0.5 | Min |
| image data center, image | center of the candidate object image data | | |
| data center) | | | |
| min(distance(candidate | Minimum distance from the center of the image | 0.5 | Min |
| object image data, image | data to any point on the candidate object image | | |
| data center)) | data | | |
| uniqueColors | Number of unique colors in the candidate object | 2.0 | Max |
| | image data | | |

For example, the banner removal process 400 can receive image data 402 and identify a center of the image data (e.g., image data center 406). The banner removal process 400 can also identify a portion of the image data that may include an item or product (e.g. candidate object image data 408 and candidate object image data center 410). The banner removal process 400 uses the image data center 406 and the candidate object image data 408 to determine the proxies and the sum of proxies to classify the portion of the image data as an item or product.

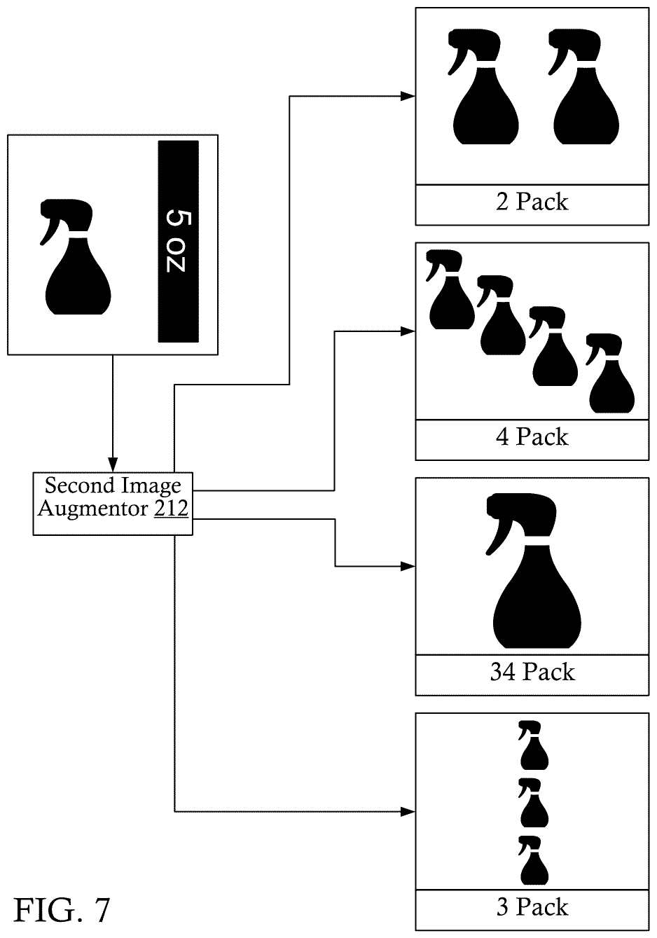

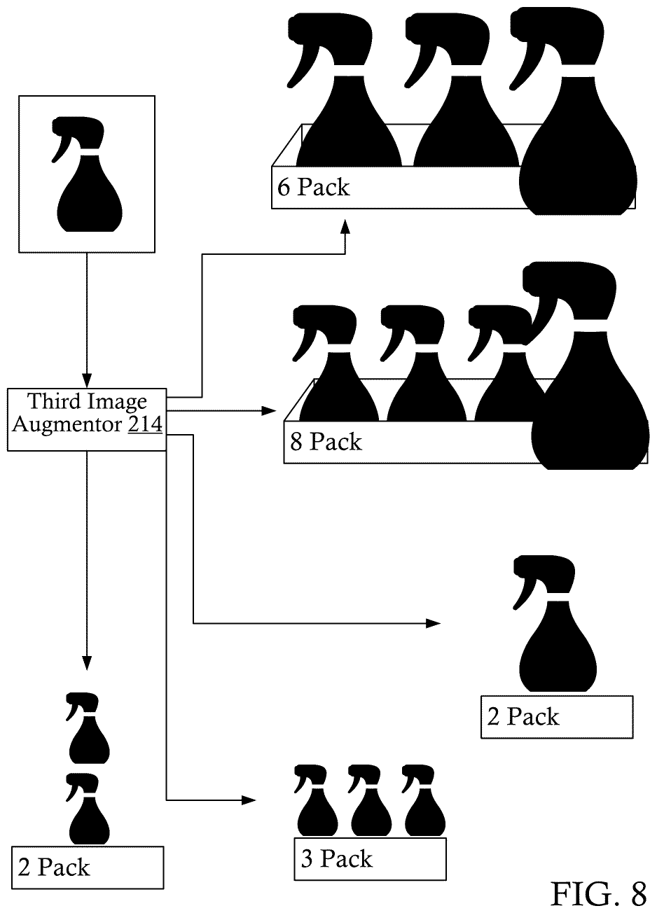

FIG. 5 depicts example generated crates and labels for augmented images, in accordance with some embodiments. The example crates and labels are generated by the cluster labeler 218 (FIG. 2). The cluster labeler 218 dynamically generates creates and/or banners to wrap around products of any size and/or shape. The cluster labeler 218 can generate at least three types of banners dynamically. Non-limiting examples of the banner types include image stacking banners (e.g., reference numbers 704, 706, 708, and 710; FIG. 7), image grouping banners (e.g., reference numbers 808, 810, and 812; FIG. 8), and image grouping crates (e.g., reference numbers 804 and 806; FIG. 8).

The cluster labeler 218 determines different dimensions for banners and crates. In particular, the cluster labeler 218 determines heights and widths for different portions of the banners and/or crates, such as quantity bar (QB) 508, left corner (LC) 504, right corner (RC) 506, front flex (FF) 509, and rear flex (RF) 502. The cluster labeler 218 receives input height and width dimensions for QB 508, LC 504, RC 506, FF 509, and RF 502, and determines output height and width dimensions (e.g., at least QB′, LC′, and RC′). Output dimensions are denoted with apostrophes. The cluster labeler 218 scales (e.g., based on a text portion scale-factor) portions of the banners and crates based on the portions that include text. For example, the quantity bar (QB) 508 includes text and the cluster labeler 218 scales the QB 508 uniformly to maintain aspect ratio text included within the QB 508. In some embodiments, the text portion scale-factor (a) is defined as:

$$α = \frac{{h}_{FF}^{′}}{{h}_{FF}}$$

or (h_{QB}), where h_{FF} (or h_{QB}) is the input height dimension of the banner or crate and

$${h}_{FF}^{′} ( or {h}_{QB}^{′} )$$

is the output (or required) height dimensions of the banner or crate.

Additionally, the cluster labeler 218 scales corner portions of the banners and crates. For example, the cluster labeler 218 can scale (e.g., based on corner portion scale-factors, described below) the right corner (RC) 506 and the left corner (LC) 504 uniformly as the corner slope of the crate (or banner) helps in depth perceptions and should remain constant. In some embodiments, the corner portion scale-factors are defined as:
LC′=scale(LC, α), where LC 504 is the input left corner dimensions and LC′ is the output left corner dimensions;
QB′=scale(QB, α), where QB 508 is the input dimensions of the QB 508 and QB′ is the output dimensions of QB 508; and
RC′=scale(RC, α), where RC 504 is the input right corner dimensions and RC′ is the output right corner dimensions.

The FF and RF components of a crate or banner are components that can be stretched independent of the aspect ratio. The cluster labeler 218 sets dimension of the FF and RF components based on other corresponding components. For example, the cluster labeler 218 can define the heights of the FF and RF components as:

$${h}_{RF}^{′} = {h}_{RC}^{′} = {h}_{LC}^{′} ; and$$

$${h}_{FF}^{′} = {h}_{QB}^{′} .$$

Similarly, the cluster labeler 218 can define the widths of the FF and RF components as:

$${w}_{FF}^{′} = {w}_{LC}^{′} + {w}_{RF}^{′} + {w}_{RC}^{′} - {w}_{QB}^{′} .$$

The above equations provide the dimension for the banners and crates. In particular, the cluster labeler 218 can create banners and (seamless) crates of any dimension, size, or aspect ratio.

FIG. 6 depicts first example augmented images, in accordance with some embodiments. In particular, FIG. 6 illustrates generation of an augmented image using the first image augmentor 210 (FIG. 2). The first image augmentor 210 is configured to generate an augmented image including a predetermined number of items (or products). In some embodiments, the predetermined number of items is at least 3 items, at least 4 items, at least 6 items, etc. In some embodiments, the first image augmentor 210 is configured to generate an augmented image including a first predetermined number of items and a second predetermined number of items. For example, the first predetermined number of items can be 1 item, and the second predetermined number of items can be at least 5 items. In some embodiments, the first predetermined number of items is a primary item (e.g., an item makes up a substantial portion of an augmented image (e.g., more than 50 percent of the augmented image).

The first image augmentor 210 applies one or more policies or rules to image data received from database 122. Example policies of the first image augmentor 210 can include an arrange-right policy 610, an arrange-bottom policy (not shown), and other policies. For brevity, the arrange-right policy 610 is described below. However, the arrange-bottom policy (and other directional policies) is similar to the arrange-right policy 610 (discussed below), but with the dimensions swapped (e.g., height swapped with width). For example, under the arrange-right policy 610, respective heights for each secondary item can be adjusted such that secondary items can be aligned to the right of the primary item (e.g., with equal scaled widths); however, under the arrange-bottom policy, respective widths for each secondary item can be adjusted such that secondary items can be aligned to the bottom of the primary item (e.g., with equal scaled heights). Further, for ease, margins and/or paddings are not included the explanations below; however, the same equations with a slightly smaller total height (or width) can be used to leave space for margins that can then be uniformly distributed.

The arrange-right policy 610 includes identifying a primary item (P) 602, a width of the primary item (W), and a height of the primary item (H). The arrange-right policy 610 also includes identifying a number of secondary items (e.g., a₀ to aₙ), a respective height for each secondary item, and a respective width for each secondary item. The arrange-right policy 610 determines a scale-factor for each secondary item (e.g., α₀ to αₙ), such that upon scaling each item with its corresponding factor, the arrange-right policy 610 generates secondary items with scaled widths (e.g., w₀′ to wₙ′) and scaled heights

$$( e . g . , {h}_{0}^{′} to {h}_{n}^{′} ) .$$

As shown by the arrange-right policy 610, the scaled widths of the secondary items are all the same

$$( e . g . , {w}_{1}^{′} = {w}_{2}^{′} ... = {w}_{n}^{′} )$$

and the sum of the scaled heights of the secondary items is equal to the height of the P 602

$$( e . g . , {\sum }_{i = 0}^{n} {h}_{i}^{′} = H ) .$$

The arrange-right policy 610 transformations can be defined as, for all i,

$${w}_{i}^{′} = {α}_{i} {w}_{i} ; and$$

$${h}_{i}^{′} = {α}_{i} {h}_{i} .$$

An aspect ratio (ARᵢ) remains constant for each (secondary) item as the (secondary) items are scaled proportionally, as described below,

$${AR}_{i} = \frac{{w}_{i}}{{h}_{i}} = \frac{{w}_{i}^{′}}{{h}_{i}^{′}}$$

As all the widths for the secondary items are the same in the arrange-right policy 610, the scaled widths, for the arrange-right policy 610, can be defined as

$${w}^{′} = \frac{H}{{\sum }_{i = 0}^{n} \frac{1}{{AR}_{i}}}$$

The equations for w′ and wᵢ′ are used to determine scale-factors do to an and the scale-factors are used with the

$${h}_{i}^{′}$$

equation to determine the dimension for the secondary items (using the arrange-right policy 610).

In an example shown in FIG. 6, the first image augmentor 210 receives image data for a primary item 602 and image data for at least three secondary items (item a 604, item b 606, and item c 608). The first image augmentor 210 applies at least the arrange-right policy 610 and the arrange-bottom policy to generate an arrange-right augmented image 630 (e.g., a first image collage augmented image with the primary item 602 disposed to the left of item a 604, item b 606, and item c 608) and arrange-bottom augmented image 640 (e.g., a second image collage augmented image with the item a 604, item b 606, and item c 608 disposed beneath primary item 602), respectively. Each augmented image generated by the first image augmentor 210 is a candidate augmented image that can be scored by the image scorer 134 (FIGS. 1 and 2).

FIG. 7 depicts second example augmented images, in accordance with some embodiments. In particular, FIG. 7 illustrates generation of augmented images using the second image augmentor 212 (FIG. 2) and received image data 702. The second augmentor 212 is configured to generate an augmented image including a predetermined number of items (or products). In some embodiments, the predetermined number of items is at least 2 items, at least 10 items, at least 34 items, etc. In some embodiments, the second augmentor 212 receives a single primary item with a predetermined number (e.g., quantity of 2, quantity of 8, quantity of 50, etc.). The second augmentor 212 generates augmented images including a predetermined number of primary items (e.g., two items in a first image stack augmented image 704), a positioning of at least one item of the predetermined number of primary items within the image stacking augmented image, and at least one banner (e.g., 2 pack banner 705).

In some embodiments, the second augmentor 212 applies at least four different policies (e.g., arrange-vertical (e.g., fourth image stack 710), arrange-horizontal (e.g., first image stack 710), stack (e.g., second image stack 706), and fallback (e.g., third image stack 710)). The second augmentor 212 identifies an “ideal aspect ratio” for the primary items. In particular, the second augmentor 212 assigns the same dimension for each primary item in an image stack augmented image and identifies an aspect ratio for each primary item in the image stack augmented image that satisfies aspect ratio criteria. In some embodiments, the ideal aspect ratio is a predetermined value (e.g., 1.21). The ideal aspect ratio can be any predetermined value based on use requirements.

The second augmentor 212 identifies a right offset (denoted by HStep or (Horizontal Step)) and a downward offset (denoted by VStep or Vertical Step). The second augmentor 212 uses the predetermined number of items (or a quantity (q)) of the primary item and calculates an adjusted height (H′) and an adjusted width (W′) of the resultant image using height and width of the primary item (H, W). The adjusted height (H′) and the adjusted width (W′) can be described as:

H′=H+(q−1)*VStep

W′=W+(q−1)*HStep

The second augmentor 212 finds minimum and maximum steps for VStep and HStep. The second augmentor 212 sets the minimum and maximum steps for VStep and HStep dynamically based on the width and height of the product itself (W, H), as shown below:

VStepₘᵢₙ=0.1*H VStepₘₐₓ=0.3*H

HStepₘᵢₙ=0.1*W HStepₘₐₓ=0.3*W

The minimum and maximum steps for VStep and HStep can be used to identify the lower and upper bounds in terms of width and height. The lower and upper bounds introduce two pairs of vertical and horizontal lines that can be disposed in a cartesian coordinate system (e.g., with an axis for width (e.g., the x-axis) and an axis for height (e.g., the y-axis)). The ideal aspect ratio can also be disposed on the cartesian coordinate system. The ideal aspect ratio can be presented as a slope on the cartesian coordinate system. The second augmentor 212 can use the cartesian coordinate system with the lower and upper bounds, the ideal aspect ratio, and the minimum and maximum steps for VStep and HStep to identify possible configurations for an image stacking augmented image. The second augmentor 212 identifies any solution on the ideal aspect ratio slope is a potential image stacking augmented image. The second augmentor 212 further selects the potential image stacking augmented image with the smallest possible size (e.g., either on the left edge or on the top edge; or left-top corner). The second augmentor 212 selects the smallest possible size as increasing size will not improve content quality since the item would be repeated over itself.

FIG. 8 depicts third example augmented images, in accordance with some embodiments. In particular, FIG. 8 illustrates generation of augmented images using the third image augmentor 214 (FIG. 2) and received image data 802. The third augmentor 214 is configured to generate an augmented image including a predetermined number of items (or products). In some embodiments, the predetermined number of items is at least 2 items, at least 3 items, at least 4 items, at least 8 items, etc. In some embodiments, the third augmentor 214 receives a single primary item with a predetermined number (e.g., quantity of 2, quantity of 8, quantity of 50, etc.). The third augmentor 214 generates augmented images including a predetermined number of primary items within, disposed over a portion, or disposed above a generated crate.

The third augmentor 214 can utilizes crates generated using the cluster labeler 218 (FIG. 2). More specifically, the third augmentor 214 uses crates generated dynamically as per a product's (or item's) dimensions. The third augmentor 214 chooses between placing a predetermined number of products (e.g., at least two, at least three, at least 4, etc.) in a generated crate based on an aspect ratio of the product. The third augmentor 214 determines a number of products that can fit within a generated crate without violating maximum aspect ratio constraints. For example, the third augmentor 214 can generate a first image grouping augmented image 804 and a second image grouping augmented image 806 with a predetermined number of products within a generated crate. In some embodiments, if a predetermined number of products does not fit within a generated crate, the third augmentor 214 generates a fallback augmented image (e.g., third image grouping 808). The fallback augmented image can use the same policy used by the second augmentor 212. Alternatively, in some embodiments, the third augmentor 214 can determine horizontal or vertical arrangements of products over a generated crate (e.g., a fourth image grouping augmented image 810 and a fifth image grouping augmented image 812).

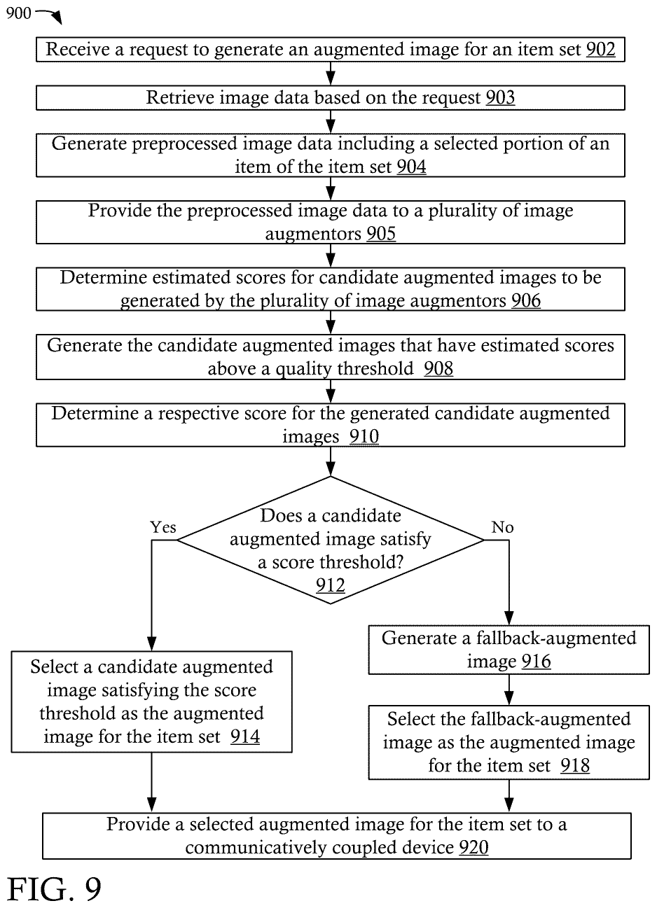

FIGS. 9-11 depict example methods for generating an augmented image, in accordance with some embodiments. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The methods shown in FIGS. 9-11 may be implemented in the form of executable instructions stored on machine-readable media and executed by a processing resource and/or in the form of electronic circuitry. For example, aspects of the methods may be described below as being performed by an image augmenting computing device 102, system 200, and/or one or more of their functions, such as image scorers 134, an image augmentors 136, an image processors 138, a fallback image augmentor 142, and an orchestrator 132 running on a hardware processing resource 104 of the image augmenting computing device 102 described above in reference to FIG. 1. Additionally, other aspects of the methods described below may be described with reference to other elements shown in FIG. 1 for non-limiting illustration purposes.

FIG. 9 depicts a flow diagram of a method for generating augmented images, in accordance with some embodiments. The method 900 includes receiving (902) a request to generate an augmented image for an item set and retrieving (903) image data based on the request. The method 900 also includes generating (904) preprocessed image data including a selected portion of an item of the item set and providing (905) the preprocessed image data to a plurality of image augmentors. The method 900 further includes determining (906) estimated scores for candidate augmented images to be generated by the plurality of image augmentors and generating (908) the candidate augmented images that have estimated scores above a quality threshold.

The method 900 further includes determining (910) a respective score for the generated candidate augmented images. The method 900 further includes determining (912) whether an augmented image score of the of the generated candidate augmented images satisfies a augmented image score threshold. In accordance with a determination that an augmented image score of the generated candidate augmented images satisfies an augmented image score threshold (“Yes” at operation 912), the method 900 includes selecting (914) a candidate augmented image satisfying the augmented image score threshold as the augmented image for the item set. Alternatively, in accordance with a determination that an augmented image score of the generated candidate augmented images does not satisfy an augmented image score threshold (“No” at operation 912), the method 900 includes generating (916) a fallback-augmented image and selecting (918) the fallback-augmented image as the augmented image for the item set.

The method 900 further includes providing (920) the selected augmented image for the item set to a communicatively coupled device.

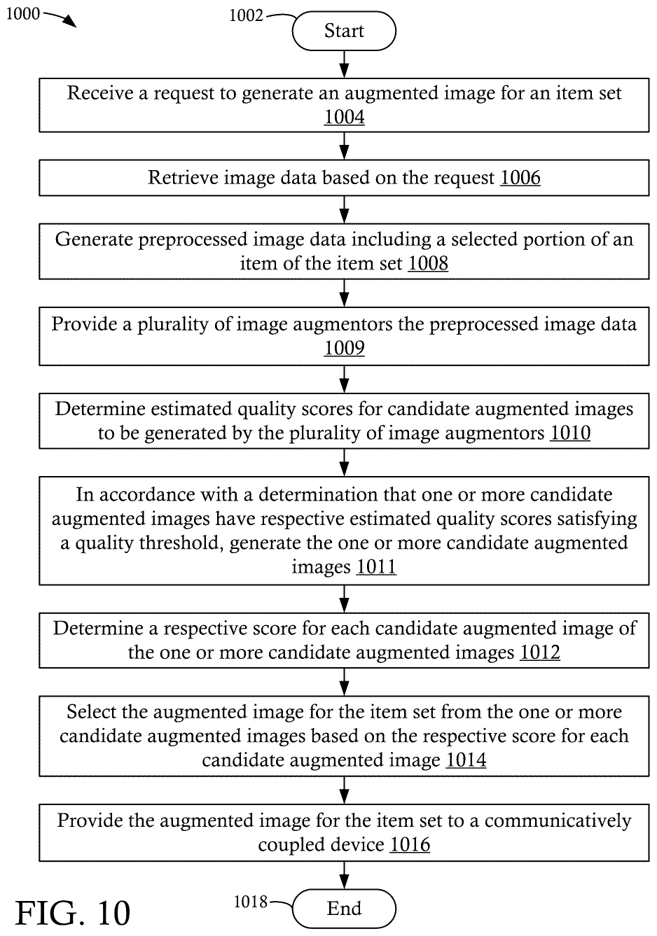

FIG. 10 depicts an example method for generating augmented images, in accordance with some embodiments. The method 1000 starts at operation (1002) and proceeds to operation (1004). Operation (1004) includes receiving a request to generate an augmented image for an item set. The method 1000 continues to operation (1006), which includes retrieving image data based on the request. The method 1000 also includes operation (1008). Operation (1008) includes generating preprocessed image data including a selected portion of an item of the item set. The method 1000 proceeds to operation (1009), which includes providing a plurality of image augmentors the preprocessed image data. The method 1000 includes operation (1010). Operation (1010) includes determining estimated quality scores for candidate augmented images to be generated by the plurality of image augmentors. The method 1000 further includes operation (1011), which includes, in accordance with a determination that one or more candidate augmented images have respective estimated quality scores satisfying augmented image quality thresholds, generating the one or more candidate augmented images. Estimated scores determined by the plurality of image augmentors are described above in reference to FIG. 2.

The method 1000 then proceeds to operation (1012). Operation (1012) includes determining a respective augmented image score for each candidate augmented image of the one or more candidate augmented images. The method 1000 further includes operation (1014). Operation (1014) includes selecting the augmented image for the item set from the one or more augmented images based on the respective augmented image score for each candidate augmented image. The method 1000 proceeds to operation (1016), which includes providing the augmented image for the item set to a communicatively coupled device. The method then ends at operation (1018).

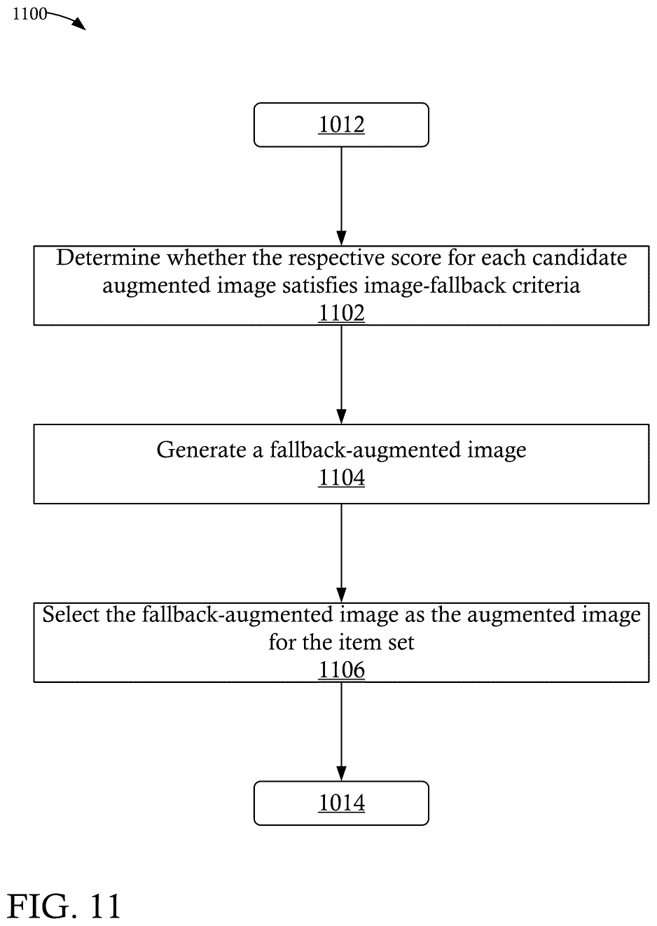

FIG. 11 depicts an example method expanding on the method for generating augmented images, in accordance with some embodiments. The method 1100 is performed after operation 1012 (and before operation 1014) of method 1000 (FIG. 10). The method 1100 includes operation (1102), which includes determining whether the respective augmented image score for each candidate augmented image satisfies image-fallback criteria. The method 1100 proceeds to operation (1104). Operation (1104) includes generating a fallback-augmented image. The method 1100 further proceeds to operation (1106), which includes selecting the fallback-augmented image as the augmented image for the item set. The method 1100 then returns to operation (1014).

In some embodiments, the methods disclosed herein further include a first image augmentor of the plurality of image augmentors that generates an image collage including at least a representation of the item of the item set. In some embodiments, generating the image collage includes determining dimensions for representations of items of the item set, generating respective weights for each representation of the items of the item set based on the dimensions for each representation of the items of the item set, and generating the image collage based on the respective weights for each representation of the items of the item set. In some embodiments, the representation of the item of the item set is assigned a greater weight than representation of other items of the item set. Examples of the image collage and the associated image augmentor are provided above in reference to FIGS. 2 and 6.

In some embodiments, the methods disclosed herein further include a second image augmentor of the plurality of image augmentors that generates an image stacking including at least one representation of the item of the item set. In some embodiments, generating the image stacking includes determining a height and a width of the at least one representation of the item of the item set, determining a horizontal step and a vertical step between each respective representation of the item of the at least one representation of the item of the item set, generating, based on the height and the width of the representation of the item of the item set, a plurality of candidate image stackings, and selecting a candidate image stacking of the plurality of candidate image stackings satisfying aspect ratio criteria as the image stacking. In some embodiments, each candidate image stacking of the plurality of candidate image stackings has a distinct horizontal step to vertical step ratio. Examples of image stacking and the associated image augmentor are provided above in reference to FIGS. 2 and 7.

In some embodiments, the methods disclosed herein further include a third image augmentor of the plurality of image augmentors that generates an image grouping at least two representation of the item of the item set. In some embodiments, generating the image grouping includes determining dimensions of a representation of the item of the item set, determining, based on the dimensions of the representation of the item, a number of representations of the item to include in the least two representation of the item of the item set, and generating, based on the number of representations of the item, the image grouping at least two representation of the item of the item set. Examples of image grouping and the associated image augmentor are provided above in reference to FIGS. 2 and 8.

In some embodiments, the image processor performs semantic segmentation on the image data. Examples of semantic segmentation are provided above in reference to FIG. 3.

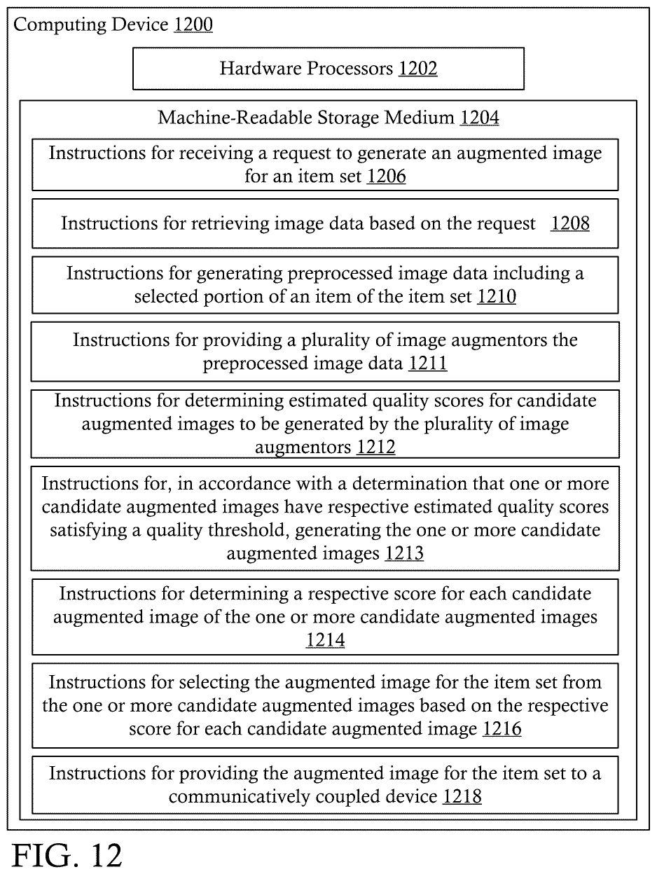

FIG. 12 depicts an example system 1200 that includes non-transitory, machine-readable media 1204 encoded with example instructions executable by processing resource 1202. In some implementations, the system 1200 may be useful for implementing aspects of the image augmenting computing device 102 of FIG. 1 and analogous systems. For example, the instructions encoded on machine-readable media 1204 may be included in instructions 108 of FIG. 1. In some implementations, functionality described with respect to FIG. 1 may be included in the instructions encoded on machine-readable media 1204.

The processing resource 1202 may include a microcontroller, a microprocessor, central processing unit core(s), an ASIC, an FPGA, and/or other hardware device suitable for retrieval and/or execution of instructions from the machine-readable media 1204 to perform functions related to various examples. Additionally or alternatively, the processing resource 1202 may include or be coupled to electronic circuitry or dedicated logic for performing some or all of the functionality of the instructions described herein.

The machine-readable media 1204 may be any medium suitable for storing executable instructions, such as RAM, ROM, EEPROM, flash memory, a hard disk drive, an optical disc, or the like. In some example implementations, the machine-readable media 1204 may be a tangible, non-transitory medium. The machine-readable media 1204 may be disposed within the system 1200 respectively, in which case the executable instructions may be deemed installed or embedded on the system. Alternatively, the machine-readable media 1204 may be a portable (e.g., external) storage medium, and may be part of an installation package.

As described further herein below, the machine-readable media 1204 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 12.

With reference to FIG. 12, the machine-readable media 1204 includes instructions 1206-1218. Instructions 1206, when executed, cause the processing resource 1202 to receive a request to generate an augmented image for an item set. Instructions 1208, when executed, cause the processing resource 1202 to retrieve image data based on the request. Instructions 1210, when executed, cause the processing resource 1202 to generate preprocessed image data including a selected portion of an item of the item set. Instructions 1211, when executed, cause the processing resource 1202 to provide a plurality of image augmentors the preprocessed image data. Instructions 1212, when executed, cause the processing resource 1202 to determine estimated quality scores for candidate augmented images to be generated by the plurality of image augmentors. Instructions 1213, when executed, cause the processing resource 1202 to, in accordance with a determination that one or more candidate augmented images have respective estimated quality scores satisfying a quality threshold, generate the one or more candidate augmented images. Instructions 1214, when executed, cause the processing resource 1202 to determine a respective augmented image score for each candidate augmented image of the one or more candidate augmented images. Instructions 1216, when executed, cause the processing resource 1202 to select the augmented image for the item set from the one or more augmented images based on the respective augmented image score for each candidate augmented image. Instructions 1218, when executed, cause the processing resource 1202 to provide the augmented image for the item set to a communicatively coupled device.

The models, when executed by the image augmenting computing device 102, allow the image augmenting computing device 102 to allocate resource and generate optimized schedules for the allocated resources. For example, the image augmenting computing device 102 may obtain one or more models from the database 122. In response to receiving a user request, the image augmenting computing device 102 may execute one or more models to determine and transmit a schedule with resource allocations. A user computing device 126 may then receive, in real-time, a schedule with resource allocations including one or more options updating and/or finalizing the schedule.

In some embodiments, the image augmenting computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, image augmenting computing device 102 may generate predicted fulfillment times for multiple users and/or for a plurality of fulfillment time windows.

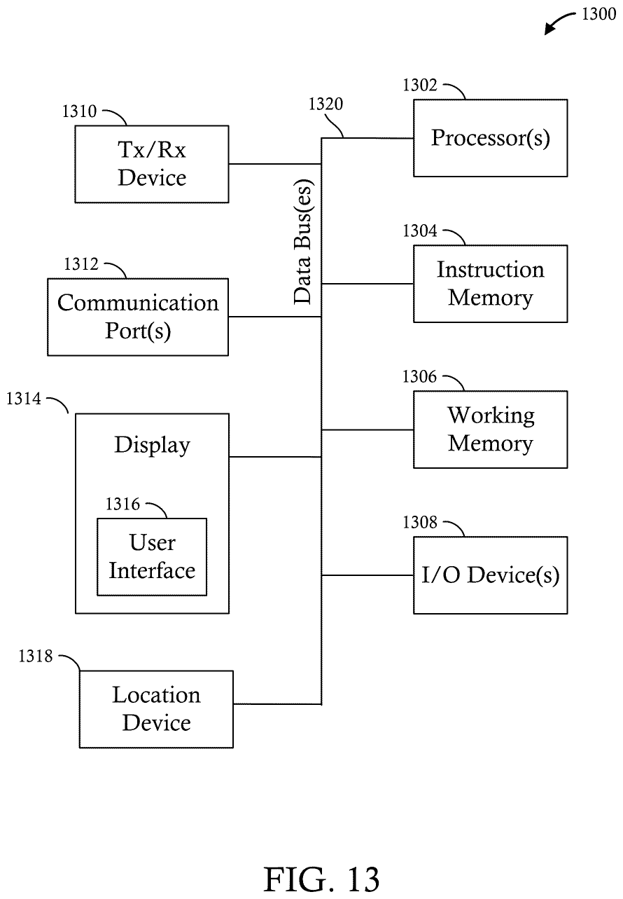

FIG. 13 illustrates a block diagram of a computing device 1300, in accordance with some embodiments. Although FIG. 13 is described with respect to certain components shown therein, it will be appreciated that the elements of the computing device 1300 may be combined, omitted, and/or replicated. In addition, it will be appreciated that additional elements other than those illustrated in FIG. 13 may be added to the computing device.

As shown in FIG. 13, the computing device 1300 may include one or more processing resources 1302, instruction memory 1304, working memory 1306, input/output devices 1308, transceiver 1310, communication ports 1312, display 1314, optional location device 1318, and/or any other suitable elements each operatively coupled to one or more data buses 1320. The data buses 1320 allow for communication among the various components. The data buses 1320 may include wired, or wireless, communication channels.

The one or more processing resources 1302 may include any processing circuitry operable to control operations of the computing device 1300. In some embodiments, the one or more processing resources 1302 include one or more distinct processors, each having one or more cores (e.g., processing circuits). Each of the distinct processors may have the same or different structure. The one or more processing resources 1302 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 1302 may also be implemented by a controller, a microcontroller, an application specific integrated circuit (ASIC), a field programmable gate array (FPGA), a programmable logic device (PLD), etc.

In some embodiments, the one or more processing resources 1302 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 1304 may store instructions that are accessed (e.g., read) and executed by at least one of the one or more processing resources 1302. For example, the instruction memory 1304 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 1302 may perform a certain function or operation by executing code, stored on the instruction memory 1304, embodying the function or operation. For example, the one or more processing resources 1302 may execute code stored in the instruction memory 1304 to perform one or more of any function, method, or operation disclosed herein.

Additionally, the one or more processing resources 1302 may store data to, and read data from, the working memory 1306. For example, the one or more processing resources 1302 may store a working set of instructions to the working memory 1306, such as instructions loaded from the instruction memory 1304. The one or more processing resources 1302 may also use the working memory 1306 to store dynamic data created during one or more operations. The working memory 1306 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 1304 and working memory 1306, it will be appreciated that the computing device 1300 may include a single memory unit that operates as both instruction memory and working memory. Further, although embodiments are discussed herein including non-volatile memory, it will be appreciated that computing device 1300 may include volatile memory components in addition to at least one non-volatile memory component.

In some embodiments, the instruction memory 1304 and/or the working memory 1306 includes an instruction set, in the form of a file for executing various methods, such as methods for generating augmented images, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 1302.

The input-output devices 1308 may include any suitable device that allows for data input or output. For example, the input-output devices 1308 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 1310 and/or the communication port(s) 1312 allow for communication with a network, such as the communication network 114 of FIG. 1. For example, if the communication network 114 of FIG. 1 is a cellular network, the transceiver 1310 allows communications with the cellular network. In some embodiments, the transceiver 1310 is selected based on the type of the communication network 114 the computing device 1300 will be operating in. The one or more processing resources 1302 are operable to receive data from, or send data to, a network, such as the communication network 114 of FIG. 1, via the transceiver 1310.

The communication port(s) 1312 may include any suitable hardware, software, and/or combination of hardware and software that is capable of coupling the computing device 1300 to one or more networks and/or additional devices. The communication port(s) 1312 may be arranged to operate with any suitable technique for controlling information signals using a desired set of communications protocols, services, or operating procedures. The communication port(s) 1312 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 1312 allows for the programming of executable instructions in the instruction memory 1304. In some embodiments, the communication port(s) 1312 allow for the transfer (e.g., uploading or downloading) of data, such as machine learning model training data.

In some embodiments, the communication port(s) 1312 couples the computing device 1300 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 1310 and/or the communication port(s) 1312 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 1314 may be any suitable display, and may display the user interface 1316. The user interfaces 1316 may enable user interaction with the augmented images and/or the image augmenting computing device 102. For example, the user interface 1316 may be a user interface for an application of a network environment operator that allows a user to view and interact with the operator's website. In some embodiments, a user may interact with the user interface 1316 by engaging the input-output devices 1308. In some embodiments, the display 1314 may be a touchscreen, where the user interface 1316 is displayed on the touchscreen.

The display 1314 may include a screen such as, for example, a Liquid Crystal Display (LCD) screen, a light-emitting diode (LED) screen, an organic LED (OLED) screen, a movable display, a projection, etc. In some embodiments, the display 1314 may include a coder/decoder, also known as Codecs, to convert digital media data into analog signals. For example, the visual peripheral output device may include video Codecs, audio Codecs, or any other suitable type of Codec.

The optional location device 1318 may be communicatively coupled to a location network and operable to receive position data from the location network. For example, in some embodiments, the location device 1318 includes a GPS device that receives position data identifying a latitude and longitude from one or more satellites of a GPS constellation. As another example, in some embodiments, the location device 1318 is a cellular device that receives location data from one or more localized cellular towers. Based on the position data, the computing device 1300 may determine a local geographical area (e.g., town, city, state, etc.) of its position.

In some embodiments, the computing device 1300 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 1300 may be a computer, a workstation, a laptop, a server such as a cloud-based server, or any other suitable device. In some embodiments, the computing device 1300 is a server that includes one or more processing units, such as one or more graphical processing units (GPUs), one or more central processing units (CPUs), and/or one or more processing cores. The computing device 1300 may, in some embodiments, execute one or more virtual machines. In some embodiments, processing resources (e.g., capabilities) of the computing device 1300 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

The communication network 114 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 114 may provide access to, for example, the Internet.

In some embodiments, training data is generated for one or more models (e.g., machine learning models, deep learning models, statistical models, algorithms, etc.) based on stored images, etc. One or more models are trained based on corresponding training data. The trained models may be stored in a database, such as in the database 122 (e.g., a cloud storage database).

The models, when executed by the image augmenting computing device 102, allow the image augmenting computing device 102 to generate augmented images. For example, the image augmenting computing device 102 may obtain one or more models from the database 122. The image augmenting computing device 102 may then receive, in real-time, a user request for generating augmented images. In response to receiving the user request for generating augmented images, the image augmenting computing device 102 may execute one or more models to generate candidate augmented images and select an augmented image from the candidate augmented images.

In some embodiments, the image augmenting computing device 102 assigns the models (or parts thereof) for execution to one or more processing devices 120. For example, each model may be assigned to a virtual machine hosted by a processing device 122. The virtual machine may cause the models or parts thereof to execute on one or more processing units such as GPUs. In some embodiments, the virtual machines assign each model (or part thereof) among a plurality of processing units. Based on the output of the models, image augmenting computing device 102 may generate the augmented images.

Training models based on training data the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

It will be appreciated that generation of augmented images as disclosed herein, is only possible with the aid of computer-assisted machine-learning algorithms and techniques, such as the image scorers 134, the image augmentors 136, the image processors 138, the fallback image augmentor 142, and the orchestrator 132. In some embodiments, machine learning processes are used to perform operations that cannot practically be performed by a human, either mentally or with assistance. It will be appreciated that a variety of machine learning techniques can be used alone or in combination to generate the allocation schedules.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a request to generate an augmented image for an item set;
retrieve, from a communicatively coupled database, image data based on the request;
generate, using an image processor, preprocessed image data including a selected portion of an item of the item set, wherein the image processor generates the preprocessed image data at predetermined rate satisfying a computational resources requirement;
provide a plurality of image augmentors the preprocessed image data;
determine estimated quality scores for candidate augmented images to be generated by the plurality of image augmentors;
in accordance with a determination that one or more candidate augmented images have respective estimated quality scores satisfying an augmented image quality threshold, generate, using the plurality of image augmentors, the one or more candidate augmented images;
determine, based on an image scorer, a respective augmented image score for each candidate augmented image of the one or more candidate augmented images;
select the augmented image for the item set from the one or more candidate augmented images based on the respective augmented image score for each candidate augmented image; and
provide the augmented image for the item set to a communicatively coupled device.

2. The system of claim 1, wherein the instructions, when executed, further cause the processor to:
determine whether the respective augmented image score for each candidate augmented image satisfies image-fallback criteria;
generate, using a fallback-image augmentor, a fallback-augmented image; and
select the fallback-augmented image as the augmented image for the item set.

3. The system of claim 1, wherein a first image augmentor of the plurality of image augmentors generates an image collage including at least a representation of the item of the item set.

4. The system of claim 3, wherein generating the image collage comprises:
determining dimensions for representations of items of the item set;
generating respective weights for each representation of the items of the item set based on the dimensions for each representation of the items of the item set, wherein the representation of the item of the item set is assigned a greater weight than representation of other items of the item set; and
generating the image collage based on the respective weights for each representation of the items of the item set.

5. The system of claim 1, wherein a second image augmentor of the plurality of image augmentors generates an image stacking including at least one representation of the item of the item set.

6. The system of claim 5, wherein generating the image stacking comprises:
determining a height and a width of the at least one representation of the item of the item set;
determining a horizontal step and a vertical step between each respective representation of the item of the at least one representation of the item of the item set;
generating, based on the height and the width of the representation of the item of the item set, a plurality of candidate image stackings, wherein each candidate image stacking of the plurality of candidate image stackings has a distinct horizontal step to vertical step ratio; and
selecting a candidate image stacking of the plurality of candidate image stackings satisfying aspect ratio criteria as the image stacking.

7. The system of claim 1, wherein a third image augmentor of the plurality of image augmentors generates an image grouping at least two representation of the item of the item set.

8. The system of claim 7, wherein generating the image grouping comprises:
determining dimensions of a representation of the item of the item set;
determining, based on the dimensions of the representation of the item, a number of representations of the item to include in the least two representation of the item of the item set; and
generating, based on the number of representations of the item, the image grouping at least two representation of the item of the item set.

9. The system of claim 1, wherein the image processor performs semantic segmentation on the image data.

10. A computer-implemented method, comprising:
receiving a request to generate an augmented image for an item set;
retrieving, from a communicatively coupled database, image data based on the request;
generating, using an image processor, preprocessed image data including a selected portion of an item of the item set, wherein the image processor generates the preprocessed image data at predetermined rate satisfying a computational resources requirement;
providing a plurality of image augmentors the preprocessed image data;
determining estimated quality scores for candidate augmented images to be generated by the plurality of image augmentors;
in accordance with a determination that one or more candidate augmented images have respective estimated quality scores satisfying an augmented image quality threshold, generating, using the plurality of image augmentors, the one or more candidate augmented images;
determining, based on an image scorer, a respective augmented image score for each candidate augmented image of the one or more candidate augmented images;
selecting the augmented image for the item set from the one or more candidate augmented images based on the respective augmented image score for each candidate augmented image; and
providing the augmented image for the item set to a communicatively coupled device.

11. The computer-implemented method of claim 10, further comprising:
determining whether the respective augmented image score for each candidate augmented image satisfies image-fallback criteria;
generating, using a fallback-image augmentor, a fallback-augmented image; and
selecting the fallback-augmented image as the augmented image for the item set.

12. The computer-implemented method of claim 10, wherein a first image augmentor of the plurality of image augmentors generates an image collage including at least a representation of the item of the item set.

13. The computer-implemented method of claim 10, wherein a second image augmentor of the plurality of image augmentors generates an image stacking including at least one representation of the item of the item set.

14. The computer-implemented method of claim 10, wherein a third image augmentor of the plurality of image augmentors generates an image grouping at least two representation of the item of the item set.

15. The computer-implemented method of claim 10, wherein the image processor performs semantic segmentation on the image data.

16. A non-transitory computer readable medium having instructions stored thereon, wherein the instructions, when executed by at least one processor, cause at least one device to perform operations comprising:
receiving a request to generate an augmented image for an item set;
retrieving, from a communicatively coupled database, image data based on the request;
generating, using an image processor, preprocessed image data including a selected portion of an item of the item set, wherein the image processor generates the preprocessed image data at predetermined rate satisfying a computational resources requirement;
providing a plurality of image augmentors the preprocessed image data;
determining estimated quality scores for candidate augmented images to be generated by the plurality of image augmentors;
in accordance with a determination that one or more candidate augmented images have respective estimated quality scores satisfying an augmented image quality threshold, generating, using the plurality of image augmentors, the one or more candidate augmented images;
determining, based on an image scorer, a respective augmented image score for each candidate augmented image of the one or more candidate augmented images;
selecting the augmented image for the item set from the one or more candidate augmented images based on the respective augmented image score for each candidate augmented image; and
providing the augmented image for the item set to a communicatively coupled device.

17. A non-transitory computer readable medium of claim 16, wherein the instructions, when executed by the at least one processor, further cause the at least one device to perform operations comprising:
determining whether the respective augmented image score for each candidate augmented image satisfies image-fallback criteria;
generating, using a fallback-image augmentor, a fallback-augmented image; and
selecting the fallback-augmented image as the augmented image for the item set.

18. A non-transitory computer readable medium of claim 16, wherein a first image augmentor of the plurality of image augmentors generates an image collage including at least a representation of the item of the item set.

19. A non-transitory computer readable medium of claim 16, wherein a second image augmentor of the plurality of image augmentors generates an image stacking including at least one representation of the item of the item set.

20. A non-transitory computer readable medium of claim 16, wherein a third image augmentor of the plurality of image augmentors generates an image grouping at least two representation of the item of the item set.
